(19) United States
(12) Patent Application Publication
(10) Pub. No.: US 2023/0051902 A1
(43) Pub. Date: Feb. 16, 2023

(54) LITHIUM SECONDARY BATTERY

(71) Applicant: SAMSUNG SDI CO., LTD., Yongin-si, Gyeonggi-do (KR)

(72) Inventors: Jungmin LEE, Yongin-si (KR); Minjae KIM, Yongin-si (KR); Seunghyun OH, Yongin-si (KR); Heeeun YOO, Yongin-si (KR); Kukjoo LEE, Yongin-si (KR)

(21) Appl. No.: 17/790,949

(22) PCT Filed: Jan. 7, 2021
(86) PCT No.: PCT/KR2021/000158

§ 371 Date: Jul. 5, 2022

(30) Foreign Application Priority Data
Jan. 7, 2020 (KR) 10-2020-0002270
Jan. 6, 2021 (KR) 10-2021-0001333

(51) Int. Cl. H01M 4/525; H01M 10/0525; H01M 4/36; H01M 4/505; H01M 50/417; H01M 10/42; H01M 4/58

(52) U.S. Cl. CPC H01M 4/525; H01M 10/0525; H01M 4/366; H01M 4/505; H01M 50/417; H01M 10/42; H01M 4/5825; H01M 2004/027

(57) ABSTRACT

Provided is a lithium secondary battery comprising: a positive electrode including a positive electrode active material; a negative electrode including a negative electrode active material; and a first functional layer between the positive electrode and the negative electrode, wherein the first functional layer includes plate-like polyolefin particles having an average diameter of 1 μm to 8 μm, and the positive electrode includes a positive electrode active material layer including a positive electrode active material and a flame retardant, or has a stacked structure including a positive electrode active material layer and a second functional layer including a flame retardant.

### TECHNICAL FIELD

A lithium secondary battery is related.

### BACKGROUND ART

A portable information device such as a cell phone, a laptop, smart phone, and the like or an electric vehicle has used a lithium secondary battery having high energy density and easy portability as a driving power source. In addition, research on use of a lithium secondary battery as a power source for a hybrid or electric vehicle or a power storage by using high energy density characteristics has recently been actively made.

One of the main research tasks of such a lithium secondary battery is to improve the safety of the secondary battery. For example, if the lithium secondary battery is exothermic due to internal short circuit, overcharge and overdischarge, and the like, and an electrolyte decomposition reaction and thermal runaway phenomenon may occur, an internal pressure inside the battery may rise rapidly to cause battery explosion. Among these, when the internal short circuit of the lithium secondary battery occurs, there is a high risk of explosion because the high electrical energy stored in each electrode is conducted in the shorted positive electrode and negative electrode.

In addition to the damage of the lithium secondary battery, the explosion may cause fatal damages to the user and thus, it is urgent to develop a technique capable of improving stability of the lithium secondary battery.

### DISCLOSURE

A lithium secondary battery having improved stability is provided. An embodiment provides a lithium secondary battery that includes a positive electrode including a positive electrode active material; a negative electrode including a negative electrode active material; and a first functional layer between the positive electrode and the negative electrode, wherein the first functional layer includes plate-like polyolefin particles having an average diameter of 1 μm to 8 μm, and the positive electrode includes a positive electrode active material layer including a positive electrode active material and a flame retardant, or has a stacked structure including a positive electrode active material layer and a second functional layer including a flame retardant.

The lithium secondary battery according to the embodiment may exhibit excellent thermal and physical safety.

### DESCRIPTION OF THE DRAWINGS

FIG. 1 is a schematic view illustrating a structure of an electrode assembly according to an embodiment.

FIG. 2 is a schematic view illustrating the structure of a lithium secondary battery according to an embodiment.

FIG. 3 is a scanning electron microscope image of polyethylene spherical particles in an aqueous dispersion state.

FIG. 4 is a scanning electron microscope image of polyethylene plate-like particles according to an embodiment.

FIG. 5 is a image of the thermal safety evaluation result of the battery cell manufactured in Comparative Example 1.

FIG. 6 is a image of the thermal safety evaluation result of the battery cell manufactured in Comparative Example 2.

FIG. 7 is a image of the thermal safety evaluation result of the battery cell manufactured in Example 1.

FIG. 8 is a image of the thermal safety evaluation result of the battery cell manufactured in Example 2.

FIG. 9 is a image of the thermal safety evaluation result of the battery cell manufactured in Example 3.

FIG. 10 is a image showing results of evaluation of penetration safety of the battery cell manufactured in Comparative Example 1.

FIG. 11 is a image showing results of evaluation of penetration stability of the battery cell manufactured in Comparative Example 2.

FIG. 12 is a image showing results of evaluation of penetration safety of the battery cell manufactured in Example 1. FIG.

FIG. 13 is a image showing results of evaluation of penetration safety of the battery cell manufactured in Example 2.

FIG. 14 is a image showing results of evaluation of penetration safety of the battery cell manufactured in Example 3.

### MODE FOR INVENTION

Hereinafter, embodiments of the present invention are described in detail. However, these embodiments are exemplary, the present invention is not limited thereto and the present invention is defined by the scope of claims.

In the present specification, when a definition is not otherwise provided, the average particle diameter may mean the diameter (D50) of particles having a cumulative volume of 50 volume % in the particle size distribution. In addition, the average particle diameter may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this.

A lithium secondary battery according to an embodiment includes a positive electrode including a positive electrode active material; a negative electrode including a negative electrode active material; and a first functional layer between the positive electrode and the negative electrode, wherein the first functional layer includes plate-like polyolefin particles having an average diameter of 1 μm to 8 μm and the positive electrode includes a positive electrode active material layer including a positive electrode active material and a flame retardant or has a stacked structure including a positive electrode active material layer and a second functional layer including a flame retardant.

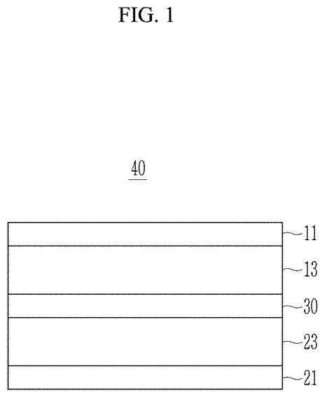

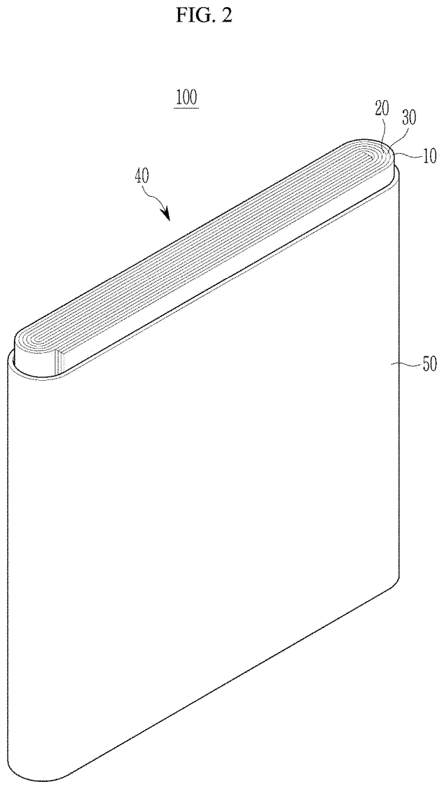

Hereinafter, the lithium secondary battery is described with reference to FIGS. 1 and 2.

FIG. 1 is a cross-sectional view of an electrode assembly included in a lithium secondary battery according to an embodiment and FIG. 2 is a schematic view illustrating a structure of a lithium secondary battery according to an embodiment of the present invention.

Referring to FIG. 1, the electrode assembly 40 includes a positive electrode 10 including a positive electrode current collector 11 and a positive electrode active material layer 13 on the positive electrode current collector 11; a negative electrode 20 including a negative electrode current collector 21 and a negative electrode active material layer 23 on the negative electrode current collector 21, and a first functional layer 30 between the positive electrode 10 and the negative electrode 20.

Referring to FIG. 2, a lithium secondary battery 100 according to an embodiment includes an electrode assembly 40 in which the positive electrode 10, the negative electrode 20, and the first functional layer 30 therebetween are wound, and a case 50 in which the assembly 40 is housed. Although the lithium secondary battery according to the embodiment is described as an example of a prismatic shape, the present invention is not limited thereto, and may be applied to various types of batteries, such as a cylindrical shape and a pouch type.

Hereinafter, the positive electrode 10 including the positive electrode current collector 11 and the positive electrode active material layer 13 on the positive electrode current collector 11 is described.

The positive electrode current collector 11 may be an aluminum foil, a nickel foil, or a combination thereof, but is not limited thereto.

According to an embodiment, the positive electrode 10 may include a positive electrode active material layer 13 including a positive electrode active material and a flame retardant.

When the flame retardant is included in the positive electrode active material layer, the flame retardant may be gasified, when a temperature is increased due to an internal short circuit by an external impact such as penetration, and thus suppress the temperature increase inside the battery and prevent the battery from igniting, improving battery safety. On the other hand, since conventional battery performance is maintained during the normal operation of the battery, the battery safety may be significantly improved, when an event occurs, and in addition, normal charge and discharge characteristics may be secured under general circumstances.

The flame retardant is a compound that delays flammability, and any material that has an endothermic action within the range of about 80° C. to 200° C. may be used without limitation. The flame retardant may be an organic flame retardant, and the organic flame retardant may be a phosphorus-based flame retardant, a halogen-based flame retardant, a nitrogen-based flame retardant, or a combination thereof.

The phosphorus-based flame retardant may be ammonium phosphate, ammonium polyphosphate, trioctyl phosphate, dimethyl methylphosphate, trimethylolpropane methylphosphonic oligomer, pentaerythritol phosphate, cyclic neopentyl thiophosphoric anhydride, triphenyl phosphate, tricresyl phosphate, tert-butylphenyl diphenyl phosphate, tetraphenyl m-p-phenylene diphosphate (tetraphenyl m-p-phenylenediphosphate), tris(2,4-dibromophenyl) phosphate, N,N′-bis(2-hydroxyethyl) am inomethyl phosphonate, phosphine oxide, phosphine oxide diols, phosphites, phosphonates, triaryl phosphate, alkyldiaryl phosphate, trialkyl phosphate, resorcinaol bisdiphenyl phosphate (RDP), or a combination thereof.

The halogen-based flame retardant may be tribromophenoxyethane, tetrabromobisphenol-A (TBBA), octabromodiphenyl ether (OBDPE), brominated epoxy, brominated polycarbonate oligomer, brominated benzyl alkyl ether, brominated benzoic acid ester, brominated phthalic acid ester, chlorinated paraffin, chlorinated polyethylene, an alicyclic chlorine-based flame retardant, or a combination thereof.

In addition, the nitrogen-based flame retardant may be melamine, melamine phosphate, melamine cyanurate, or a combination thereof.

A content of the flame retardant may be 0.001 wt % to 30 wt %, for example 0.01 wt % to 20 wt %, 0.1 wt % to 15 wt %, 0.1 wt % to 10 wt %, 0.1 wt % to 5 wt %, or 0.1 wt % to 4 wt % based on the total amount of the positive electrode active material layer. While securing the safety of the battery within the above range, a decrease in battery performance due to a decrease in electrical conductivity may be suppressed.

The positive electrode active material may include a compound including at least one of composite oxides of lithium and a metal selected from cobalt, manganese, nickel, and a combination thereof.

Specifically, the compound including at least one of composite oxides of lithium and a metal selected from cobalt, manganese, nickel, and a combination thereof may be a compound represented by any one of the following chemical formulas. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2).

In chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound. For example, the method may include any coating method (e.g., spray coating, dipping, etc.), but is not illustrated in more detail since it is well-known to those skilled in the related field.

The positive electrode active material layer may further include the compound of Chemical Formula 1.

Liₐ₁Fe₁₋ₓ₁Mₓ₁PO₄ [Chemical Formula 1]

In Chemical Formula 1, 0.90≤a1≤1.8, 0≤x1≤0.7, and M is Mg, Co, Ni or a combination thereof.

When the compound of Chemical Formula 1 is included in the positive electrode active material layer 13, a mixing ratio of the positive electrode active material including at least one of composite oxides of lithium and a metal selected from cobalt, manganese, nickel, and a combination thereof, and the compound represented by Chemical Formula 1 may be a weight ratio of 9:1 to 5:5. Since the compound represented by Chemical Formula 1 has low electronic conductivity, when it is included in an excess outside the above range, the resistance increases and the output characteristic is lowered, which is not preferable, while when it is included in too small a quantity, it is difficult to achieve the desired thermal safety effect.

The positive electrode active material layer 13 may further include a binder and a conductive material. Examples of the binder may include polyvinyl alcohol, carboxymethyl cellulose, hydroxypropyl cellulose, diacetyl cellulose, polyvinyl chloride, polyvinyl fluoride, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like. In addition, in an embodiment, as the binder, an organic binder may be an organic binder that is polyvinyl fluoride, polyvinylpyrrolidone, polyurethane, polytetrafluoroethylene, polyvinylidene fluoride, polyethylene, polypropylene, or a combination thereof.

The conductive material is included to provide a positive electrode with conductivity and any electrically conductive material may be used as a conductive material unless it causes a chemical change. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

According to another embodiment, the positive electrode may have a stacked structure including a positive electrode active material layer and a second functional layer including a flame retardant. The second functional layer may be present between the positive electrode active material layer and the positive electrode current collector, may be present on the positive electrode active material layer, or both.

The positive electrode active material layer may include a positive electrode active material, and optionally a binder and a conductive material, and the descriptions thereof are as described above.

The positive electrode active material layer and/or the second functional layer may further include the compound of Chemical Formula 1. When the compound of Chemical Formula 1 is included in the positive electrode active material layer and/or the second functional layer, it is appropriate to enhance safety.

An average particle diameter of the compound of Chemical Formula 1 may be less than or equal to 2 μm, or 0.2 μm to 1 μm. When the average particle diameter of the compound of Chemical Formula 1 is greater than 1 μm, it is not appropriate because the electronic conductivity is lowered, the utilization rate of the compound of Chemical Formula 1 may be lowered, battery resistance may be increased, and cycle life characteristics may be deteriorated. In the present specification, when a definition is not otherwise provided, the average particle diameter may mean the diameter (D50) of particles having a cumulative volume of 50 volume % in the particle size distribution.

The compound represented by Chemical Formula 1 included in the positive electrode active material layer and the second functional layer may be the same or different each other.

The second functional layer may further include an aqueous binder. The aqueous binder may be a binder strong against oxidation, for example, any aqueous binder having oxidation resistance under a positive electrode potential of less than or equal to 4.45 V (vs. Li⁺). Examples of the aqueous binder may include a styrene-butadiene rubber, an acrylate-based compound, an imide-based compound, a polyvinylidene fluoride-based compound, a polyvinylpyrrolidone-based compound, a nitrile-based compound, an acetate-based compound, a cellulose-based compound, a cyano-based compound.

Specific examples of the acrylate-based compound may include polyacrylic acid (PAA), polymethylmethacrylate, polyisobutylmethacrylate, polyethylacrylate, polybutylacrylate, poly(2-ethylhexyl acrylate), or a combination thereof.

Specific examples of the imide-based compound may include polyimide, polyamide imide, or a combination thereof. In addition, specific examples of the polyvinylidene fluoride-based compound may include polyvinylidene fluoride-co-hexafluoropropylene, polyvinylidene fluoride-co-trichloroethylene, polyvinylidene fluoride-co-tetrafluoro ethylene, polyvinylidene fluoride-co-trifluoroethylene, polyvinylidene fluoride-co-trifluorochloroethylene, polyvinylidene fluoride-co-ethylene fluoride-hexafluoropropylene (polyvinylidene fluoride-co-hexafluoropropylene: PVdF), polyvinylidene fluoride-trichloroethylene, or a combination thereof, and specific examples of the polyvinylpyrrolidone-based compound may include polyvinylpyrrolidone, or a combination thereof.

In addition, specific examples of the nitrile-based compound may include polyacrylonitrile, an acrylonitrile styrene-butadiene copolymer, or a combination thereof, specific examples of the acetate-based compound may include polyvinyl acetate, ethylene-co-vinyl acetate (polyethylene-co-vinyl acetate), cellulose acetate, cellulose acetate butyrate, cellulose acetate propionate, or a combination thereof, specific examples of the cellulosic compound may include cyanoethyl cellulose, carboxyl methyl cellulose, or a combination thereof, and specific examples of the cyano-based compound may include cyanoethyl sucrose.

The binder having excellent oxidation resistance may be well combined with the compound of Chemical Formula 1 as well as a compound reversibly intercalating and deintercalating lithium of the positive electrode active material layer and thereby, maintain a strong bond between the second functional layer and the positive electrode active material layer.

When the aqueous binder is used for the second functional layer, water that does no damage on electrodes during the formation of the second functional layer may be appropriately used as a solvent. However, when an organic binder, not the aqueous binder, is used for the second functional layer, an organic solvent used in forming the first functional layer and the second functional layer may damage the electrodes, that is, cause a spring back problem, which may deteriorate electronic conductivity and excessively increase a battery thickness and thus have an adverse structural effect on the active material layer.

The second functional layer may have a thickness of 1 μm to 13 μm, and according to another embodiment, the thickness may be 2 μm to 4 μm. When the second functional layer has a thickness within the ranges, safety may be enhanced.

The positive electrode active material layer may have a thickness of 60 μm to 70 μm, for example, 30 μm to 70 μm. When the positive electrode active material layer has a thickness within the ranges, energy density may be increased according to the thickening.

In addition, a ratio of the thickness of the positive electrode active material layer to that of the second functional layer thickness may be 30:1 to 10:1. When the positive electrode active material layer and the second functional layer have a thickness ratio within the range, a second functional layer improving safety, while minimizing a decrease in energy density, may be obtained. In particular, as the thickness of the second functional layer and the thickness of the active material layer are within the ranges, when the ratio of the thickness of the second functional layer to that of the positive electrode active material layer is within the ranges, safety may be enhanced by setting an appropriate thickness of the second functional layer according to the thickness of the positive electrode active material layer.

The thickness of the positive electrode active material layer may be a thickness after a compression process during the manufacture of the positive electrode.

When the second functional layer includes the compound of Chemical Formula 1 and the aqueous binder, a mixing ratio thereof may be 24:1 to 50:1, for example, 43:1 to 50:1. When the compound of Chemical Formula 1 and the aqueous binder are mixed within the ranges, there may be advantages as an appropriate ratio in terms of energy density, adherence, dispersibility, and the like.

When the second functional layer includes the compound of Chemical Formula 1 and the aqueous binder, a thickener may be further included. As the thickener, one or more of carboxymethyl cellulose, hydroxypropylmethyl cellulose, methyl cellulose, or alkali metal salts thereof may be mixed and used. The alkali metals may be Na, K, or Li. When the second functional layer further includes a thickener, a content of the thickener may be 0.6 parts by weight to 2 parts by weight based on 100 parts by weight of the compound of Chemical Formula 1. When the content of the thickener is within this range, there may be advantages of improving thickening and dispersibility, while minimizing an increase in resistance.

The positive electrode may be prepared by coating positive electrode active material slurry on a current collector and then, drying and compressing it to form a positive electrode active material layer and coating positive electrode functional layer slurry including a flame retardant and an aqueous binder on the positive electrode active material layer. The positive electrode functional layer slurry may be further compressed after the drying.

Accordingly, the cathode active material layer may have a dense structure, and the second functional layer may have a porous structure. The positive electrode active material slurry includes a positive electrode active material which is the compound including at least one of composite oxides of lithium and a metal selected from cobalt, manganese, nickel, and a combination thereof and/or the compound represented by Chemical Formula 1, a binder, a conductive material, and an organic solvent, and the second functional layer slurry includes a flame retardant, an aqueous binder, and a water solvent. As the organic solvent, N-methyl pyrrolidone may be used. In addition, each content of the positive electrode active material, the binder, and the conductive material in the positive electrode active material slurry may be appropriately used to obtain the aforementioned positive electrode active material layer composition, and a content of the flame retardant and the aqueous binder in the second functional layer may be appropriately used to obtain the aforementioned second functional layer composition.

The negative electrode 20 facing the positive electrode 10 includes a negative electrode current collector 21 and a negative electrode active material layer 23 on the negative electrode current collector 21.

The negative current collector 21 may include one selected from a copper foil, a nickel foil, a stainless steel foil, a titanium foil, a nickel foam, a copper foam, a polymer substrate coated with a conductive metal, and a combination thereof. The negative electrode active material layer 23 includes a negative electrode active material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include a carbon material. The carbon material may be any generally-used carbon-based negative electrode active material in a lithium ion secondary battery and examples thereof may be crystalline carbon, amorphous carbon, or a mixture thereof. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be may be Si, SiOx (0≤x≤2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, but not Sn), and the like, and at least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be vanadium oxide, lithium vanadium oxide, or lithium titanium oxide.

In the negative electrode active material layer 23, a content of the negative electrode active material may be 95 wt % to 99 wt % based on the total weight of the negative electrode active material layer.

In an embodiment, the negative electrode active material layer 23 may include a binder and optionally a conductive material. In the negative electrode active material layer 23, a content of the binder may be 1 wt % to 5 wt % based on the total weight of the negative electrode active material layer. In addition, when the conductive material is further included, 90 wt % to 98 wt % of the negative electrode active material, 1 wt % to 5 wt % of the negative electrode active material, and 1 wt % to 5 wt % of the conductive material may be included.

The binder improves binding properties of negative electrode active material particles with one another and with a current collector. The binder includes a non-water-soluble binder, a water-soluble binder, or a combination thereof.

The non-water-soluble binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide polytetrafluoroethylene, or a combination thereof.

The water-soluble binder may be a styrene-butadiene rubber, an acrylated styrene-butadiene rubber (SBR), an acrylonitrile-butadiene rubber, an acrylic rubber, a butyl rubber, a fluorine rubber, an ethylene propylene copolymer, polyethylene oxide, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the water-soluble binder is used as a negative electrode binder, a cellulose-based compound may be further used to provide viscosity as a thickener. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of 0.1 parts by weight to 3 parts by weight based on 100 parts by weight of the negative electrode active material.

The conductive material may include a carbon-based material such as natural graphite, artificial graphite, carbon black, acetylene black, ketjen black, carbon fiber, and the like; a metal-based material such as a metal powder or metal fiber, and the like of copper, nickel, aluminum silver, and the like; a conductive polymer such as a polyphenylene derivative, and the like, or a mixture thereof.

The functional layer 30 between the positive electrode 10 and the negative electrode 20 may include plate-like polyolefin particles having an average diameter of 1 μm to 8 μm.

For example, the functional layer 30 may be formed on the negative electrode active material layer 23 including the negative electrode active material. Herein, since the functional layer 30 may serve as a separator preventing direct contact between the positive electrode 10 and the negative electrode 20, a lithium secondary battery including the same may not include a separate separator.

According to another embodiment, the functional layer 30 may be formed on one surface of the separator to be in contact with the negative electrode active material layer 23.

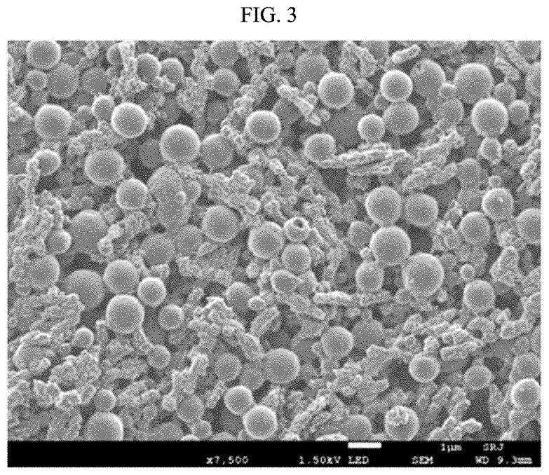

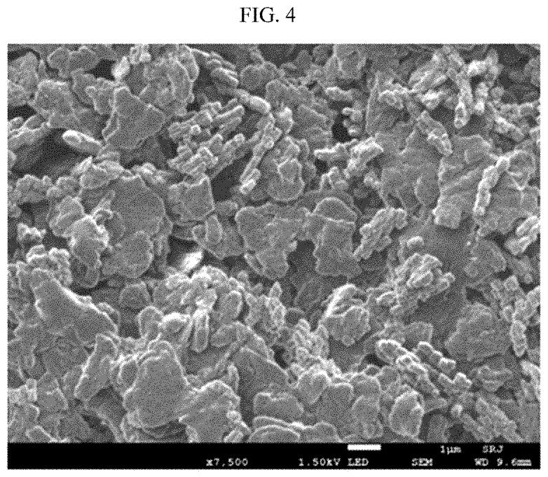

The functional layer 30 may have an advantage of improving thermal and physical safety of the battery by rapidly shutting down the battery in an abnormal operation or thermal runaway situation. A shape of the plate-like polyethylene particles is described with reference to FIGS. 3 and 4. FIG. 3 is a scanning electron microscope (SEM) image of polyethylene spherical particles in a dispersion state, and FIG. 4 is a SEM image of plate-like polyethylene particles. FIGS. 3 and 4 show a difference of the shape of the plate-like polyethylene particles from that of conventional spherical polyethylene particles. Accordingly, when the plate-like polyolefin particles according to an embodiment are used, the functional layer 30 may be formed to be thinner and wider, compared with the conventional spherical shape polyolefin particles and also, rapidly melt the plate-like polyolefin particles to close an ion passage with a large area.

In general, polyolefin, for example, polyethylene may be classified depending on density into HDPE (high density polyethylene, density: 0.94 g/cc to 0.965 g/cc), MDPE (medium density polyethylene, density: 0.925 g/cc to 0.94 g/cc), LDPE (low density polyethylene, density: 0.91 g/cc to 0.925 g/cc), VLDPE (very low density polyethylene, density: 0.85 g/cc to 0.91 g/cc), and the like.

The plate-like polyolefin particles may include polyethylene, polypropylene, polybutylene, or a copolymer thereof, or a mixture thereof. The polyethylene particles may use, for example, a polyethylene polymer such as HDPE, MDPE, LDPE, and the like singularly or as a mixture of two or more.

The plate-like polyolefin particles may have a melting point (Tm) of 80° C. tot 150° C., for example, 90° C. to 140° C.

The plate-like polyolefin particles may have density of 0.91 g/cc to 0.98 g/cc and specifically, 0.93 g/cc to 0.97 g/cc.

A particle size of the plate-like polyolefin particle may be 1 μm to 8 μm, for example, greater than or equal to 1.5 μm, greater than or equal to 2.0 μm, or greater than or equal to 2.5 μm, and less than or equal to 8 μm, less than or equal to 7.5 μm, less than or equal to 7 μm, less than or equal to 6.5 μm, less than or equal to 6.0 μm, less than or equal to 5.5 μm, less than or equal to 5 μm, less than or equal to 4.5 μm, less than or equal to 4 μm, less than or equal to 3.5 μm, or less than or equal to 3 μm.

A ratio of a major axis length to a minor axis length of the plate-shaped polyolefin particles may be 1 to 5, specifically 1.1 to 4.5, for example, 1.2 to 3.5.

In addition, a thickness of the plate-like polyolefin particle may be 0.2 μm to 4 μm, specifically, 0.3 μm to 2.5 μm, 0.3 μm to 1.5 μm, or 0.3 μm to 1 μm.

When the size, the ratio of the major axis length to the minor axis length, and the thickness of the plate-like polyolefin particle are within the above ranges, the battery performance may be secured by minimizing the movement resistance of lithium ions, and the shut-down function is further strengthened to suppress the heat generation of the battery early.

The functional layer 30 may further include inorganic particles and a binder in addition to the plate-like polyolefin particles. Accordingly, the shut-down function of the plate-like polyethylene may not only suppress battery exothermicity early but also prevent a short circuit between the positive electrode and the negative electrode from electrical insulation of the inorganic particles, and the binder may bind the plate-like polyethylene with the inorganic particles and also bind them to the negative electrode active material layer. Accordingly, thermal/physical safety and cycle-life characteristics of the battery may be improved.

The inorganic particles may include, for example, Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but are not limited thereto. In addition, the organic particles including an acrylic compound, an imide compound, an amide compound, or a combination thereof in addition to the inorganic particles may be further included, but the present invention is not limited thereto. The inorganic particles may have a spherical shape, a sheet shape, a cubic shape, or an amorphous shape. An average particle diameter of the inorganic particle may be 1 nm to 2500 nm, for example, 100 nm to 2000 nm, 200 nm to 1000 nm, or 300 nm to 800 nm.

A total amount of the plate-like polyolefin particles and the inorganic particles may be 80 wt % to 99 wt %, specifically 85 wt % to 97 wt %, 90 wt % to 97 wt %, 93 wt % to 97 wt % or 95 wt % to 97 wt % based on the total weight of the functional layer 30.

The plate-like polyolefin particles and the inorganic particles may be included in a weight ratio of 95:5 to 10:90, for example, 75:25 to 30:70, 70:30 to 35:65, 65:35 to 40:60, 60:40 to 45:55, or 55:45 to 50:50. Accordingly, the thickness of the functional layer 30 may be appropriately adjusted and the safety of the battery may be effectively improved.

The binder may be the same as that used for the negative electrode active material layer, and is not particularly limited as long as it is a binder generally used in a lithium secondary battery. Accordingly, the binder may be included in an amount of 1 wt % to 20 wt %, specifically 3 wt % to 15 wt %, 3 wt % to 10 wt %, 3 wt % to 7 wt % or 3 wt % to 5 wt % based on the total weight of the functional layer 30.

A thickness of the functional layer 30 may be 1 μm to 10 μm, for example, 2 μm to 8 μm or 3 μm to 7 μm.

The negative electrode 20 may be manufactured by coating negative electrode active material slurry on a current collector and then, drying and compressing it to form a negative electrode active material layer and then, coating functional layer slurry including the plate-like polyolefin particles having an average diameter of 1 μm to 8 μm on the negative electrode active material layer and drying it. After the drying the functional layer slurry, a compression process may be further performed.

Accordingly, the negative electrode active material layer 23 may have a dense structure, and the functional layer 30 may have a porous structure. The negative electrode active material slurry includes a negative electrode active material which is a material that reversibly intercalates/deintercalates lithium ions, a lithium metal, a lithium metal alloy, a material capable of doping/dedoping lithium, or a transition metal oxide, a binder, a conductive material, and water, and the functional layer slurry includes the plate-like polyolefin particles having an average diameter of 1 μm to 8 μm, inorganic particles, a binder, and an organic solvent. As the organic solvent, an alcohol-based solvent may be used. In addition, each content of the negative electrode active material, the binder, and the conductive material in the negative electrode active material slurry may be appropriately used to obtain the aforementioned negative electrode active material layer composition and each content of the plate-like polyolefin particles having an average diameter of 1 μm to 8 μm, the inorganic particles, and the binder in the functional layer may be appropriately used to obtain a composition of the aforementioned functional layer 30.

When the lithium secondary battery according to an embodiment further includes a separator, the functional layer may be formed on one surface of the separator, and in this case, the same functional layer slurry as described above may be used. The separator may be polyethylene, polypropylene, polyvinylidene fluoride, or a polymer multilayer film having two or more layers thereof and may be a mixed polymer multilayer film such as a polyethylene/polypropylene double-layered separator, a polyethylene/polypropylene/polyethylene triple-layered separator, a polypropylene/polyethylene/polypropylene triple-layered separator. Alternatively, the separator may be one in which a ceramic such as Al₂O₃ or SiO₂ is coated on the polymer multilayer film.

The positive electrode 10, the negative electrode 20, and the functional layer 30 may be impregnated with an electrolyte solution (not shown).

The electrolyte solution includes a non-aqueous organic solvent and a lithium salt.

The non-aqueous organic solvent serves as a medium for transmitting ions taking part in the electrochemical reaction of a battery.

The non-aqueous organic solvent may be a carbonate-based, ester-based, ether-based, ketone-based, or alcohol-based solvent, or aprotic solvent.

The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may be methyl acetate, ethyl acetate, n-propyl acetate, dim ethylacetate, methylpropionate, ethyl propionate, decanolide, mevalonolactone, caprolactone, and the like. The ether-based solvent may be dibutyl ether, tetraglyme, diglyme, dimethoxyethane, 2-methyltetrahydrofuran, tetrahydrofuran, and the like. In addition, the ketone-based solvent may be cyclohexanone, and the like. In addition, the alcohol-based solvent may be ethanol, isopropyl alcohol, and the like and the aprotic solvent may be nitriles such as R—CN (where R is a C2 to C20 linear, branched, or cyclic hydrocarbon group and may include a double bond, an aromatic ring, or an ether bond), and the like, amides such as dimethylformamide, dioxolanes such as 1,3-dioxolane, sulfolanes, and the like.

The organic solvent may be used alone or in a mixture and when the organic solvent is used in a mixture, the mixture ratio may be controlled in accordance with a desirable battery performance.

In addition, in the case of the carbonate-based solvent, a mixture of a cyclic carbonate and a chain carbonate may be used. In this case, when the cyclic carbonate and the chain carbonate are mixed in a volume ratio of 1:1 to 1:9, the electrolyte may exhibit excellent performance.

The organic solvent may further include an aromatic hydrocarbon-based organic solvent in addition to the carbonate-based solvent. In this case, the carbonate-based solvent and the aromatic hydrocarbon-based organic solvent may be mixed in a volume ratio of 1:1 to 30:1.

As the aromatic hydrocarbon-based solvent, an aromatic hydrocarbon-based compound represented by Chemical Formula 3 may be used.

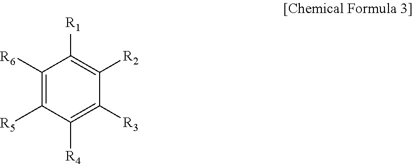

In Chemical Formula 3,

R₁ to R₆ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate-based compound of Chemical Formula 4 in order to improve cycle-life of a battery.

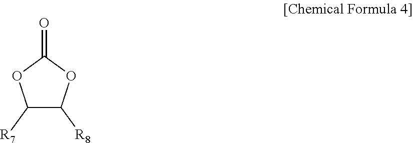

In Chemical Formula 4,

R₇ and R₈ are the same or different, and are selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and both of R₇ and R₈ are not hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate or fluoroethylene carbonate, and the like. The amount of the additive for improving cycle-life may be used within an appropriate range.

The lithium salt dissolved in the organic solvent supplies a battery with lithium ions, basically operates the lithium secondary battery, and improves transportation of the lithium ions between a positive electrode and a negative electrode. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein, x and y are natural numbers, for example an integer of 1 to 20), lithium difluoro(bisoxolato) phosphate, LiCl, LiI, LiB(C₂O₄)₂ (lithium bis(oxalato) borate: LiBOB), and lithium difluoro(oxalato)borate (LiDFOB).

A concentration of the lithium salt may range from 0.1 M to 2.0 M. When the lithium salt is included at the above concentration range, an electrolyte may have excellent performance and lithium ion mobility due to optimal electrolyte conductivity and viscosity.

Hereinafter, examples of the present invention and comparative examples are described. However, these examples are exemplary, and the present disclosure is not limited thereto.

### EXAMPLE 1

(1) Manufacture of Positive Electrode

LiNi_{0.6}Co_{0.2}Mn_{0.2}O₂ and LiNi_{0.6}Co_{0.2}Al_{0.2}O₂ were mixed in a weight ratio of 80:20 to prepare an active material, this mixed active material was mixed with LiFePO₄ having an average particle diameter (D50) of 0.42 μm in a weight ratio of 98:2 to prepare a positive electrode active material, and then, 96 wt % of the positive electrode active material, 2 wt % of a polyvinylidene fluoride binder, and 2 wt % of a ketjen black conductive material were mixed in an N-methylpyrrolidone solvent to prepare positive electrode active material slurry, and 2 parts by weight of a melamine-based flame retardant based on 100 parts by weight of the positive electrode active material slurry was added thereto, preparing positive electrode active material slurry including the flame retardant. The positive electrode active material slurry including the flame retardant was coated on an aluminum current collector and then, dried and compressed, manufacturing a positive electrode.

(2) Manufacture of Negative Electrode

97 wt % of graphite as a negative electrode active material, 1 wt % of carboxylmethyl cellulose, and 2 wt % of a styrene butadiene rubber were mixed in an aqueous solvent, preparing negative electrode active material slurry. The negative electrode active material slurry was coated on a copper current collector and then, dried and compressed, manufacturing a negative electrode.

(3) Manufacture of First Functional Layer

48 wt % of plate-like polyethylene having a particle size of about 2 μm, a length ratio of a major axis to a minor axis of about 2, and a thickness of about 0.6 μm, 47 wt % of alumina having an average particle diameter (D50) of 0.7 μm, and 5 wt % of an acrylated styrene-based rubber binder were mixed in an alcohol-based solvent, preparing first functional layer slurry. The first functional layer slurry was coated on the negative electrode active material layer of the negative electrode and dried, forming a first functional layer acting as a separator.

(4) Manufacture of Battery Cell

The negative electrode having the first functional layer and the positive electrode were used with an electrolyte prepared by dissolving 1.0 M LiPF₆ in a mixed solvent of ethylene carbonate and dimethyl carbonate in a volume ratio of 50:50, manufacturing a lithium secondary battery cell.

### EXAMPLE 2

A positive electrode and a lithium secondary battery cell were manufactured in the same manner as in Example 1 except that the positive electrode active material slurry was prepared without adding the flame retardant, but a second functional layer including the flame retardant was formed on the current collector. Specifically, the same melamine-based flame retardant as used in Example 1, a carboxylmethyl cellulose thickener, and an acrylate-based compound binder in a weight ratio of 2:1:1.5 were mixed in a water solvent, preparing second functional layer slurry. The second functional layer slurry was coated on a current collector and then, dried, forming a second functional layer. On this second functional layer, positive electrode active material slurry to which the flame retardant was not added was coated and then, dried and compressed, manufacturing a positive electrode.

### EXAMPLE 3

A positive electrode and a lithium secondary battery cell were manufactured in the same manner as in Example 1 except that the flame retardant was not added to the positive electrode active material slurry, but a second functional layer including the flame retardant was formed on the positive electrode active material layer. specifically, the positive electrode active material slurry to which the flame retardant was not added was coated and dried on a current collector, and the second functional layer slurry prepared in Example 2 was coated thereon and then, dried and compressed, manufacturing the positive electrode.

### COMPARATIVE EXAMPLE 1

A positive electrode and a lithium secondary battery cell were manufactured in the same manner as in Example 1 except that the flame retardant was not added to the positive electrode active material slurry.

### COMPARATIVE EXAMPLE 2

A positive electrode, a negative electrode, and a lithium secondary battery cell were manufactured in the same manner as in Example 1 except that a polyethylene/polypropylene two-layered separator was used without introducing the first functional layer.

### EVALUATION EXAMPLE 1

### Evaluation of Thermal Safety

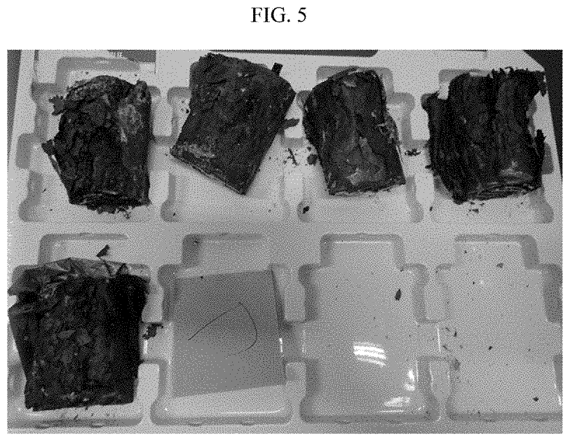

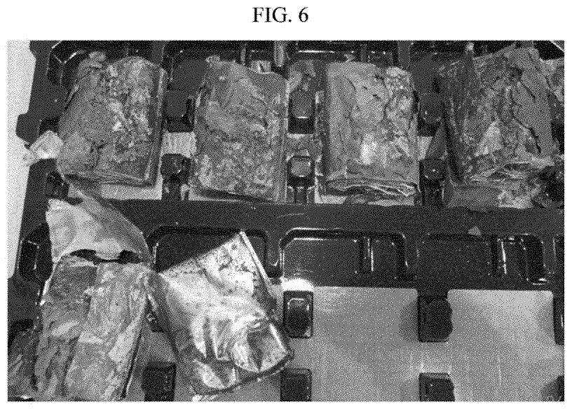

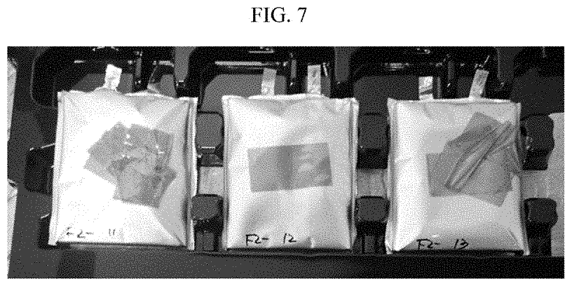

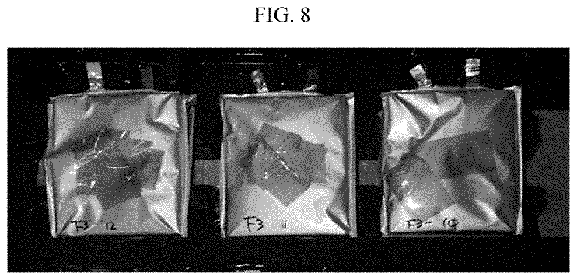

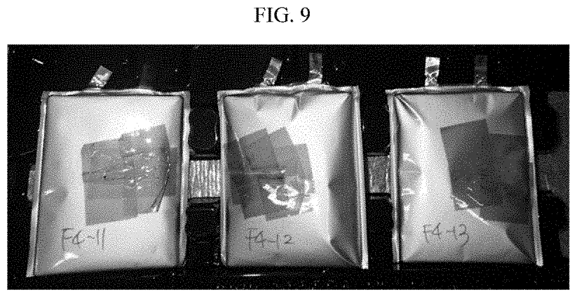

The lithium secondary battery cells according to Examples 1 to 3 and Comparative Examples 1 to 2 were charged at 4.3 V and 0.5 C rate, cut off at 0.05 C rate, and stored in a 134° C. chamber and then, examined, and the results of Comparative Examples 1 and 2 and Examples 1, 2, and Example 3 are sequentially shown in FIGS. 5 to 9.

In Comparative Example 1, five out of five battery samples were all exploded, in Comparative Example 2, six out of six battery samples were all exploded, but in Examples 1 to 3, none of three battery samples was exploded. The cells according to the examples succeeded in early shutdown during the thermal runaway, thereby securing thermal safety.

### EVALUATION EXAMPLE 2

### Penetration Safety Evaluation

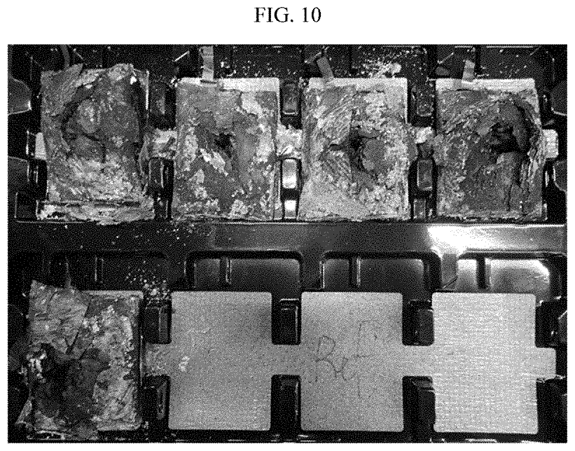

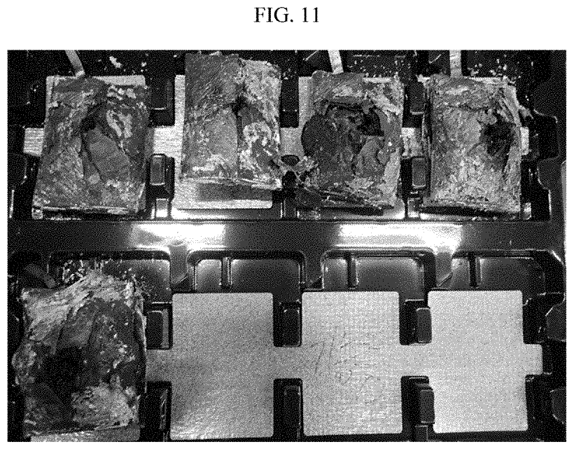

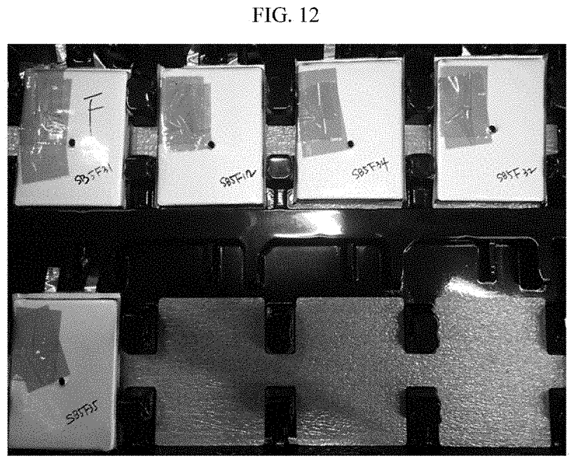

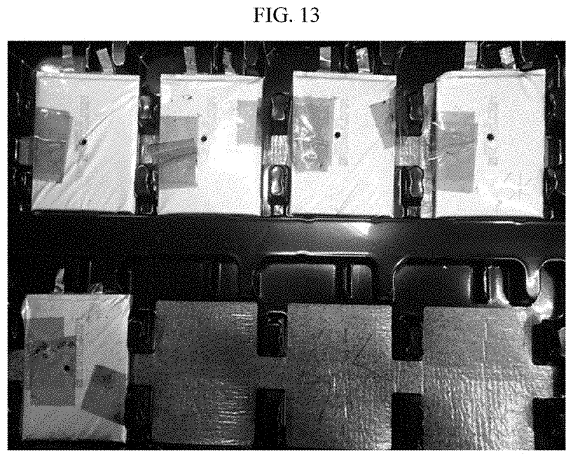

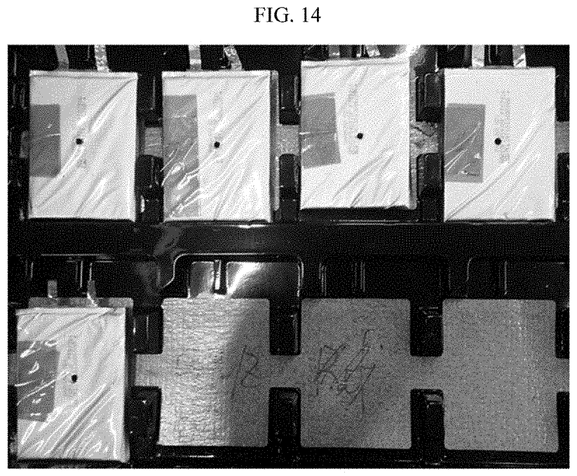

The cells according to Examples 1 to 3 and Comparative Examples 1 to 2 were charged at 4.3 V, 0.5 C rate and cut off at 0.05 C rate and one hour later, completely penetrated through the center at 80 mm/sec by using a pin with a diameter of 3 mm and then, examined, and the results of Comparative Examples 1 and 2 and Examples 1, 2, and 3 are sequentially shown in FIGS. 10 to 14.

In Comparative Examples 1 and 2, five out of five battery samples were all exploded, but in Examples 1 to 3, none of five battery samples was exploded. The cells according to the examples succeeded in early shutdown before the explosion or ignition due to the penetration, thereby securing penetration safety.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

10: positive electrode

11: positive electrode current collector

13: positive electrode active material layer

20: negative electrode

21: negative current collector

23: negative electrode active material layer

30: functional layer

40: electrode assembly

50: case

100: lithium secondary battery

1. A lithium secondary battery, comprising
a positive electrode including a positive electrode active material;
a negative electrode including a negative electrode active material; and
a first functional layer between the positive electrode and the negative electrode,
wherein the first functional layer includes plate-like polyolefin particles having an average diameter of 1 μm to 8 μm, and
the positive electrode includes a positive electrode active material layer including a positive electrode active material and a flame retardant, or
the positive electrode has a stacked structure including a positive electrode active material layer and a second functional layer including a flame retardant.

2. The lithium secondary battery of claim 1, wherein
the lithium secondary battery includes the positive electrode active material layer and a positive electrode current collector supporting it, and
the second functional layer is present between the positive electrode active material layer and the positive electrode current collector, is present on the positive electrode active material layer, or both.

3. The lithium secondary battery of claim 1, wherein
the second functional layer further includes a compound of Chemical Formula 1:
Liₐ₁Fe₁₋ₓ₁Mₓ₁PO₄ [Chemical Formula 1]
wherein, in Chemical Formula 1,
0.90≤a1≤1.8, 0≤x1≤0.7, and M is Mg, Co, Ni, or a combination thereof.

4. The lithium secondary battery of claim 1, wherein
the positive electrode active material layer includes a compound including at least one of composite oxides of lithium and a metal selected from cobalt, manganese, nickel, and a combination thereof.

5. The lithium secondary battery of claim 4, wherein
the positive electrode active material layer further includes a compound of Chemical Formula 1:
Liₐ₁Fe₁₋ₓ₁Mₓ₁PO₄ [Chemical Formula 1]
wherein, in Chemical Formula 1,
0.90≤a1≤1.8, 0≤x1≤0.7, and M is Mg, Co, Ni, or a combination thereof.

6. The lithium secondary battery of claim 1, wherein
the first functional layer is present on the negative electrode active material layer.

7. The lithium secondary battery of claim 1, wherein
the lithium secondary battery further includes a separator, and
the first functional layer is present on the separator.

8. The lithium secondary battery of claim 1, wherein
the flame retardant is an organic flame retardant.

9. The lithium secondary battery of claim 8, wherein
the organic flame retardant is a phosphorus-based flame retardant, a halogen-based flame retardant, a nitrogen-based flame retardant, or a combination thereof.

10. The lithium secondary battery of claim 9, wherein
the phosphorus-based flame retardant is ammonium phosphate, ammonium polyphosphate, trioctyl phosphate, dimethyl methylphosphate, trimethylolpropane methylphosphonic oligomer, pentaerythritol phosphate, cyclic neopentyl thiophosphoric anhydride, triphenyl phosphate, tricresyl phosphate, tert-butylphenyl diphenyl phosphate, tetraphenyl m-p-phenylene diphosphate (tetraphenyl m-p-phenylenediphosphate), tris(2,4-dibromophenyl) phosphate, N,N′-bis(2-hydroxyethyl) am inomethyl phosphonate, phosphine oxide, phosphine oxide diols, phosphites, phosphonates, triaryl phosphate, alkyldiaryl phosphate, trialkyl phosphate, resorcinaol bisdiphenyl phosphate (RDP), or a combination thereof.

11. The lithium secondary battery of claim 9, wherein
the halogen-based flame retardant is tribromophenoxyethane, tetrabromobisphenol-A (TBBA), octabromodiphenyl ether (OBDPE), brominated epoxy, brominated polycarbonate oligomer, brominated benzyl alkyl ether, brominated benzoic acid ester, brominated phthalic acid ester, chlorinated paraffin, chlorinated polyethylene, an alicyclic chlorine-based flame retardant, or a combination thereof.

12. The lithium secondary battery of claim 9, wherein
the nitrogen-based flame retardant is melamine, melamine phosphate, melamine cyanurate, or a combination thereof.

13. The lithium secondary battery of claim 1, wherein an average particle size of the plate-like polyolefin particle is 2 μm to 6 μm.

14. The lithium secondary battery of claim 1, wherein
a ratio of a major axis length to a minor axis length of the plate-like polyolefin particle is 1 to 5.

15. The lithium secondary battery of claim 1, wherein
a thickness of the plate-like polyolefin particle is 0.2 μm to 4 μm.
